(19) United States
(12) Patent Application Publication
(10) Pub. No.: US 2011/0010997 A1
(43) Pub. Date: Jan. 20, 2011

(54) Storm and guard shutter assembly for building external opening with quick emergency escape mechanism

(76) Inventor: Nikolai Kislov, Tampa, FL (US)

Correspondence Address: MICHAEL J. COLITZ, JR., 640 Douglas Avenue, DUNEDIN, FL, 34698, US

(21) Appl. No.: 12/657,308

(22) Filed: Jan. 19, 2010

Related U.S. Application Data
(60) Provisional application No. 61/225,642, filed on Jul. 15, 2009.

(51) Int. Cl. E06B 5/00; E05C 1/08; E05C 1/10; E06B 3/30

(52) U.S. Cl. 49/141; 292/137; 292/138; 292/140; 52/202

(57) ABSTRACT

A quick emergency escape mechanism for a shutter assembly for a building external opening has an engaging wall member adapted to be secured to a base coupled to a building structure in the vicinity of a building opening. The engaging wall member has an engaging part and a part for securing to the building structure. An engaging shutter member is adapted to be secured to a shutter panel and has an engaging part and a securing part for securing to a shutter panel. An engaging sliding latch member fastens and locks the engaging parts of the wall and shutter members and has fastening means and locking means.

### RELATED APPLICATION

The present non-provisional application is based upon pending Provisional Application No. 61/225,642 filed Jul. 15, 2009, the subject matter of which is incorporated herein by reference.

### BACKGROUND OF THE INVENTION

1. Field of the Invention

The present invention relates generally to a storm and guard shutter assembly for building external openings and, more particularly, to a window and door shutter for both guarding as a security barrier to deter an intruder from entering the building and storm shielding as a storm barrier to protect the window and door from strong winds and wind-borne debris, which are accompanied by a quick out of fire, flood, or other emergency window and door escape mechanism.

2. Description of the Prior Art

Both window and door guards are conventionally used to prevent unauthorized entry through window and door openings. Storm shutters are needed to protect a building from wind damage by flying debris during hurricanes or cyclones. Known prior art includes U.S. Pat. Nos. 6,205,713 and 6,293,059 which are made up of heavy plywood panels; U.S. Pat. Nos. 5,487,244, 5,596,849, 5,768,833, 5,996,292, and 6,209,263 which are made up of corrugated aluminum or still panels; U.S. Pat. Nos. 5,457,921 and 6,470,639 which are made up of corrugated and solid translucent plastic panels, respectively; U.S. Pat. No. 4,416,084 which is made up of protector bars extending across the window. The above mentioned permanently installed window and door guards, as well as a variety of others not mentioned here and hurricane shutters, have a number of drawbacks. Among them, the most important is that in the event of fire or other emergency, it is impossible for someone inside of the building to leave the building through the permanently guarded or fastened from outside window or door. The ideal emergency unlocking mechanism for a window guard should be easily unlocked in the event of an emergency, but when it is locked, difficult to remove, thus providing a high degree of security. However, particularly for hurricane shutters, it would also be desirable in some situations to have an additional option that, in the case of emergency, allows easy unlocking from both inside by a building occupant and outside by emergency personnel.

U.S. Pat. No. 4,333,271 to DePaolo et al. discloses hurricane panels mounted on the outer side of the opening to protect the opening against the effects of winds and atmospheric conditions. A security means is installed at the outer side of the panel to preserve the installation against unauthorized removal of the panel for gaining entrance to the premises. However, the security means is secured from the inner side of the panel from inside of the building, making the release of the panel from inside in the case of emergency impossible.

Most of prior art patents dealing with window protective devices equipped with emergency exit options are directed toward burglar guards. U.S. Pat. No. 2,222,866 to Graig, discloses burglar guards mounted on the outer side of the opening to protect the opening of unoccupied building against breakage by vandals or the theft of property inside of the building. Nevertheless, the construction allows its dismounting from inside, such option has never been considered in the disclosure. In addition, emergency quick dismounting of such construction will be very difficult to perform by an untrained person.

U.S. Pat. No. 4,562,666 to Young, Ill. discloses a burglar guard for windows and doors, which is constructed of unbreakable, bullet-resistant, transparent sheet material, such as polycarbonate or Lexan plastic which is installed on the interior of the building window openings. Such cover can be quickly removed from inside in the case of emergency, however, it does not protect against breakage of windows by both vandals and hurricane/tornado wind and debris.

Publication No. US 2006/0283131 and U.S. Pat. No. 7,438,336 to Wolf and Clark disclose a hurricane shutter escape mechanism for allowing removal of a conventional hurricane shutter from a window or door of a structure in the event of emergency. It can be activated from both inside and outside of the building opening. However, in this construction, the spring-actuated panel fastener is installed on each hurricane shutter panel. Therefore, if a person escaping from inside of the building or a rescuer from the outside wants to gain access through the opening, the escaper/rescuer has to manually remove a sufficient number of the spring-actuated panel fasteners, which may be difficult, especially in the case of panic. The disclosed rope mechanism for releasing an array of actuating arms appears to be unreliable. With the exception of this reference, applicant is unaware of another presently available apparatus and structure for storm protection which is equipped with a quick emergency escape mechanism that can be activated from both inside and outside of the building.

Furthermore, applicant is unaware any hurricane shutter escape mechanism which allows removal of a conventional hurricane shutter from a window or door of a structure in the event of emergency which can be activated from both inside and outside of the building opening while keeping a security means installed at the outer side of the panel to preserve the installation against unauthorized removal of the panel to gain entrance to the premises.

In addition, even though a conventional hurricane shutter is efficient in the protection of a building opening from the destructive force of storm systems, such as hurricanes, applicant is unaware of presently available designs capable of providing both an easy escape mechanism in the case of emergency and an enhanced security of the building against an unwanted intrusion.

Moreover, applicant is unaware of presently available hurricane shutter systems providing weather-tight and/or water-tight seals of the shutter as well as additional thermal insulation qualities while maintaining a quick emergency escape capability and enhanced security of the building against an unwanted intrusion.

### SUMMARY OF THE INVENTION

The main object of the present invention is to provide a quick fire or other emergency escape mechanism for a shutter protecting a window, door, or other opening, which will overcome the shortcomings of the prior art devices.

Another object is to provide a quick fire or other emergency escape mechanism for a hurricane protective shutter which can be activated easily and quickly by people from inside of the building.

An additional object is to provide a quick fire or other emergency escape mechanism for a hurricane protective shutter which can be activated easily and quickly by both people within the building and by emergency personnel outside of the building in the case of incapacity of the people inside of the building.

A further object is to provide a quick fire or another emergency escape mechanism for a security shutter which is normally in a locked position and also maintain a storm protective utility protecting window, door, or other openings of a building which can be activated easily and quickly by people from inside the building. The object is to prevent entry through the window, door, or another opening to reduce burglaries when the building is empty or unoccupied during an evacuation period and a post-evacuation period when people have returned back home but the area is still at the risk of a criminal entry.

A still further object is to provide weather-tight and/or water-tight seals of the shutter against its adjacent wall allowing a variety of marine and coastal applications to fulfill requirements that the closures be capable of sealing interiors from exposure to salt water while maintaining a quick emergency escape capability.

Still another object is to provide additional thermal insulation qualities while upgrading the security of a building against an unwanted intrusion as well as providing a quick emergency escape capability.

A still further object is to provide a quick fire or other emergency escape mechanism for a shutter which is reliable and easy to install and use.

A yet further object is to provide a quick fire or other emergency escape mechanism for a shutter which is cost effective and uses conventionally available construction and manufacturing materials without significant investment for production of non-standard parts and equipment.

Further aspects and advantages of this invention will be evident from the following detailed description, which proceeds with reference to the accompanying drawings.

### BRIEF DESCRIPTION OF THE DRAWINGS

The present invention can be described by reference to the following figures.

FIG. 1 is a perspective view of one embodiment of the present storm shutter quick emergency escape mechanism mounted over the window/door sill which is equipped with overlapped engaging sectional members and a removable sliding latch member.

FIG. 2 is a perspective view of another embodiment of the present storm shutter quick emergency escape mechanism with overlapped engaging sectional members and removable latch member which is extended from the wall of the building structure and mounted over the extended angled mount.

FIG. 3 is a perspective view of still another embodiment of the present storm shutter quick emergency escape mechanism with overlapped engaging sectional members and a sliding latch member with cut openings for quick release of shutter engaging sectional members secured to the shutter panel, which is mounted over the extended angled mount secured to the outside wall of the building structure.

FIG. 4A is a perspective view of one embodiment of the present storm shutter quick emergency escape mechanism mounted over the window/door sill, which is equipped with two elongated members and removable sliding latch member.

FIG. 4B is a perspective view of a flat shutter panel applied to the embodiment of FIG. 4A.

FIG. 4C is a perspective view of aligned vertically corrugated shutter panels applied to the embodiment of FIG. 4A.

FIG. 5A is a cross-sectional view of the latching mechanism in a locked position taken along a line A-A of FIG. 4A.

FIG. 5B is a cross-sectional view of the latching mechanism in an unlocked position taken along a line A-A of FIG. 4A.

FIG. 6A is a cross-sectional view of the latching mechanism, which is mounted over the window/door sill, in a locked position taken along a line A-A across the whole window/door opening of FIG. 4A.

FIG. 6B is a cross-sectional view of the latching mechanism, which is mounted over the window/door sill, in an emergency open position taken along a line A-A across the whole window/door opening of FIG. 4A.

FIG. 7A is a perspective view of one embodiment of the present storm shutter quick emergency escape mechanism mounted over the extended angled mount secured to the outside wall of the building structure which is equipped with two coming into contact engaging elongated members and removable sliding latch member.

FIG. 7B is a perspective view of a flat shutter panel applied to the embodiment of FIG. 7A.

FIG. 7C is a perspective view of aligned vertically corrugated shutter panels applied to the embodiment of FIG. 7A.

FIG. 8A is a cross-sectional view of the latching mechanism, which is mounted over the extended angled mount to the outer wall of a building, in a locked position taken along line A-A of FIG. 7A.

FIG. 8B is a cross-sectional view of the latching mechanism, which is mounted over the extended angled mount to the outer wall of a building, in an emergency open position taken along line A-A of FIG. 7A.

FIG. 8C is a cross-sectional view of a modified latching mechanism shown in FIGS. 8A and 8B, which is mounted over an extended angled mount to the outer wall of a building and is locked by the padlock accessible from inside and outside of the building, in a locked position.

FIG. 8D is a cross-sectional view of the latching mechanism of FIG. 8C which is shown in an unlocked position.

FIG. 8E is a cross-sectional view of the latching mechanism similar to shown in FIG. 8C, whiCh is equipped with burglary protective brackets and shown in a locked position.

FIG. 8F is a perspective view of the securing bracket 19-UB having slot 19-UBS for hiding the wall fasteners 18-T.

FIG. 8G is a cross-sectional view of the latching mechanism shown in FIG. 8E in an unlocked position.

FIG. 9A is a perspective view of another embodiment of the present storm shutter quick emergency escape mechanism mounted over the window/door sill, which is equipped with two elongated members and a sliding latch member having cut openings for quick release of shutter engaging sectional parts of the elongated member secured to the shutter panel.

FIG. 9B is a perspective view of a flat shutter panel applied to the embodiment of FIG. 9A.

FIG. 9C is a perspective view of aligned vertically corrugated shutter panels applied to the embodiment of FIG. 9A.

FIG. 10A is a perspective view of another embodiment of the present storm shutter quick emergency escape mechanism mounted over the left and right sides of the window/door opening which is equipped with two elongated members and a sliding removable latch member for quick release of shutter engaging elongated member secured to the shutter panel.

FIG. 10B is a perspective view of a flat shutter panel applied to the embodiment of FIG. 10A.

FIG. 10C is a perspective view of aligned horizontally corrugated shutter panels applied to the embodiment of FIG. 9A.

FIG. 11A is a perspective view of another embodiment of the present storm shutter quick emergency escape mechanism mounted over the left and right sides of the window/door opening which is equipped with two elongated members and a sliding latch member having cut openings for quick release of shutter engaging sectional parts of the elongated member secured to a shutter panel.

FIG. 11B is a perspective view of a flat shutter panel applied to the embodiment of FIG. 11A.

FIG. 11C is a perspective view of aligned horizontally corrugated shutter panels applied to the embodiment of FIG. 11A.

FIG. 12A is a cross-sectional view of the latching mechanism with a corrugated shutter panel fastened by wing nuts taken along line B-B of FIG. 10A and FIG. 11A.

FIG. 12B is a cross-sectional view of the latching mechanism with a corrugated shutter panel fastened by burglary preventive permanent fasteners, such as a flush lever, taken along line B-B of FIG. 10 A and FIG. 11A.

FIG. 12C is a typical cross-sectional view of the latching mechanism installed on an angled base, which is mounted on the side window opening that is not straight against an outside wall of the building, with a corrugated shutter panel fastened by burglary preventive permanent fasteners, such as a flush lever, taken along a line B-B of FIG. 10 A and FIG. 11A.

FIG. 13 is an outside front view of an embodiment of the present guard shutter assembly with quick emergency escape mechanism mounted over all four sides of the window/door opening in a locked position, which is equipped with each side elongated coupled members with two of them, left and right, latched by latch members having cut openings for quick release of shutter engaging sectional parts of the elongated member secured to a shutter panel, similar to FIG. 11, with the third, bottom, latched by sliding removable latch member, similar to FIG. 4, and with the fourth one, top, latched by removable latch member 12-T.

FIG. 14 is an inside front view of the same embodiment of the present guard shutter assembly with quick emergency escape mechanism shown in FIG. 13.

FIG. 15 is an outside front view of the embodiment of the present guard shutter assembly with quick emergency escape mechanism shown in FIG. 13, which is in an unlocked position.

FIG. 16A is a cross-sectional view of the latching mechanism with a flat shutter panel fastened by burglary preventive permanent fasteners such as a combination of a flush lever nut and a tamper resistant screw taken along a line C-C of FIG. 13 in a locked position.

FIG. 16B is a cross-sectional view of the latching mechanism with a transparent/translucent flat shutter panel fastened by burglary preventive permanent fasteners such as a combination of a flush lever nut and a tamper-resistant screw taken along line C-C of FIG. 16 in an unlocked position.

FIG. 17 is an outside front view of the top portion of the embodiment of the present guard shutter assembly with quick emergency escape mechanism, which is in a locked position on the left side, similar to FIG. 13, and in an unlocked position on the right side, similar to FIG. 15.

FIG. 18A is a cross-sectional view of the top latching mechanism in a locked position, which is taken along line D-D of FIG. 13.

FIG. 18B is a cross-sectional view of the top latching mechanism in an unlocked position, which is taken along line D-D of FIG. 16.

FIG. 19 is an outside front view of an embodiment of the present guard shutter assembly with hermetic sealing and quick emergency escape mechanism mounted over all four sides of the window/door opening in a locked position, which is equipped with each side coming into contact engaging elongated coupled members with three of them, left and right, and bottom latched by latch members having cut openings for quick release of shutter engaging sectional parts of the elongated member secured to a shutter panel, similar to shown in FIG. 11, and with the fourth one, top, latched by removable latch member 12-T in addition to the hermetic gasket around the window/door opening.

FIG. 20A is a cross-sectional view of the top latching mechanism in an unlocked/unsealed position, which is taken along a line D-D of FIG. 19.

FIG. 20B is a cross-sectional view of the top latching mechanism in a locked/sealed position, which is taken along line D-D of FIG. 19.

FIG. 20C is a cross-sectional view of the top latching mechanism installed on an angled base, which is mounted on the top sill of the window/door opening that is not straight against an outside wall of the building in an unlocked/unsealed position, which is taken along a line D-D of FIG. 19.

FIG. 20D is a cross-sectional view of the top latching mechanism as of FIG. 20C in a locked/sealed position, which is taken along a line D-D of FIG. 19.

FIG. 20E is a perspective view of a window/door opening with angled bases on all sides of the opening, which are mounted on the window/door sills and sides that are not straight against an outside wall of the building, for mounting the latching assemblies as well as for better sealing of the window opening in a locked position, which also can function as a decorative frame around the opening.

FIG. 21A is a cross-sectional view of the side, right, latching mechanism in an unlocked/unsealed position, which is taken along a line E-E of FIG. 19.

FIG. 21B is a cross-sectional view of the side, right, latching mechanism in an unlocked/unsealed position, which is taken along a line F-F of FIG. 21A.

FIG. 22A is a cross-sectional view of the side, right, latching mechanism in a locked/sealed position, which is taken along a line E-E of FIG. 19.

FIG. 22B is a cross-sectional view of the side, right, latching mechanism in a locked/sealed position, which is taken along a line F-F of FIG. 22A.

FIG. 23A is an inside front view of the latch gear assembly in an unlocked position.

FIG. 23B is an inside front view of the latch gear assembly in a locked position.

FIG. 24A is an inside front view of the latch cam gear assembly in an unlocked position.

FIG. 24A is an inside front view of the latch cam gear assembly in a locked position.

### DESCRIPTION OF THE PREFERRED EMBODIMENTS

In the following description of the preferred embodiments, reference is made to accompanying drawings that form a part hereof, and in which is shown by way of illustration a specific embodiment in which the invention may be practiced. It is to be understood that other embodiments may be utilized and structural changes may be made without departing from the scope of the present invention.

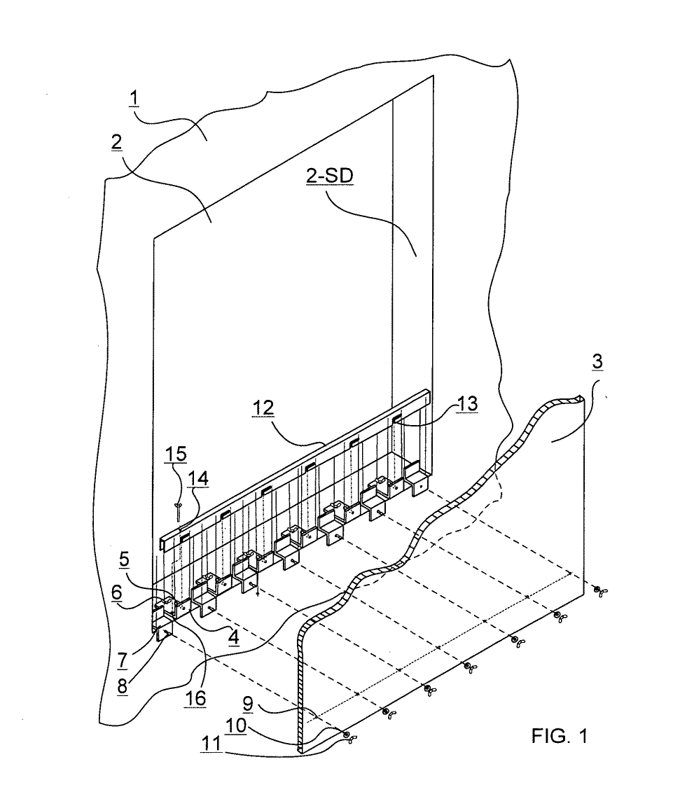

Referring now to FIG. 1, a hurricane protection window guard having an emergency quick escape mechanism mounted over the window/door sill 2-S which is equipped with overlapped engaging sectional members 4 secured to the sill 2-S and 7 secured to the shutter panel 3, which are kept in the engaged position by the removable sliding latch member 12 and locked by inserting pin/padlock 15 into aligned apertures 14 and 16.

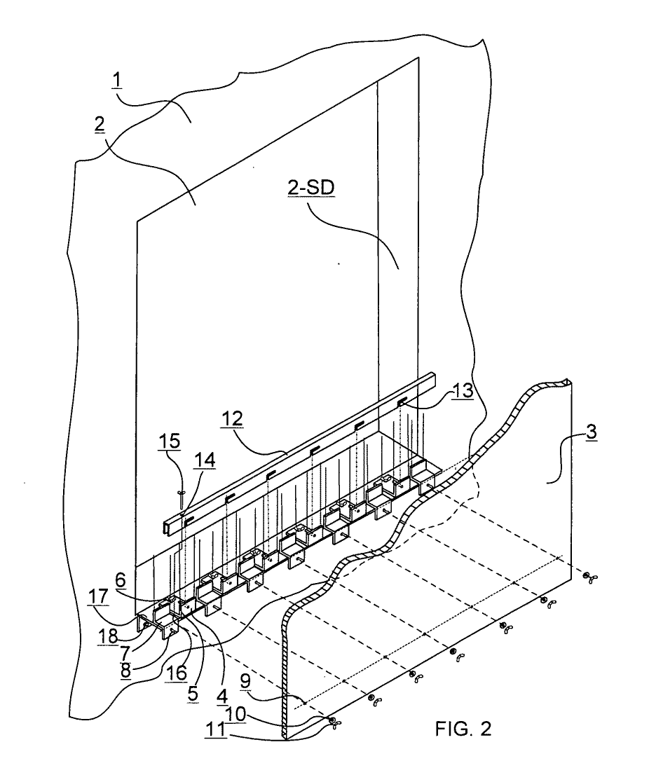

FIG. 2 is a perspective view of another embodiment of the present storm shutter quick emergency escape mechanism, which is extended from the wall 1 of the building structure and mounted over the extended angled mount 17, with overlapped engaging sectional members 4 secured to the sill 2-S and 7 secured to the shutter panel 3, which are kept in the engaged position by the removable sliding latch member 12 and locked by inserting pin/padlock 15 into aligned apertures 14 and 16.

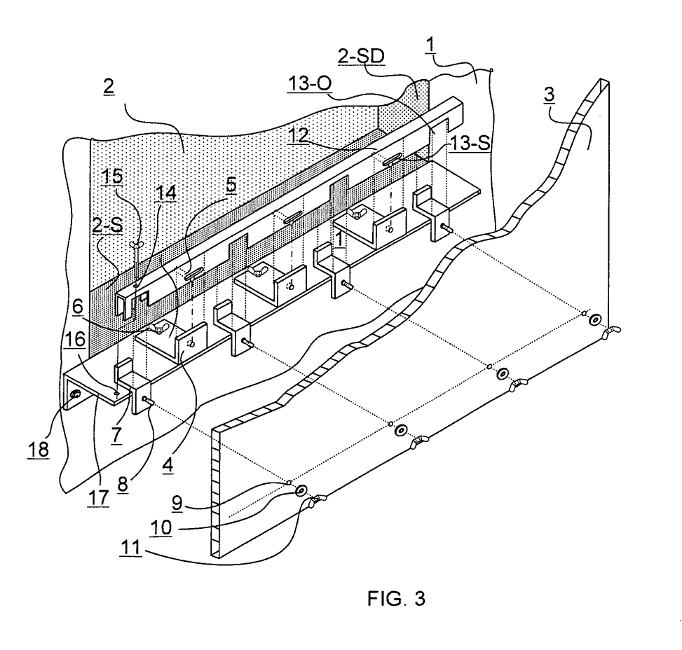

Another alternate embodiment of the invention is shown in FIG. 3. In this embodiment the storm shutter quick emergency escape mechanism is extended from the wall 1 of the building structure and mounted over the extended angled mount 17, with overlapped engaging sectional members 4 secured to the sill 2-S and 7 secured to the shutter panel 3, which are kept in the engaged position by the removable sliding latch member 12 and locked by inserting pin/padlock 15 into aligned apertures 14 and 16. In this design, the sliding latch elongated member 12 is a U-shaped bar with the outer width equal to the distance between overlapped engaging parts 4 and 7 and fastening means in the form of elongated closed slots with the slot width allowing studs 5 and 8 to be inserted and slide and open slots 13-O on both sides of the latch elongated member with the open slot width and height allowing shutter engaging parts 4 and 7 to be inserted through the U-shaped bar and positioned so that open slot parts are aligned with the shutter engaging parts position.

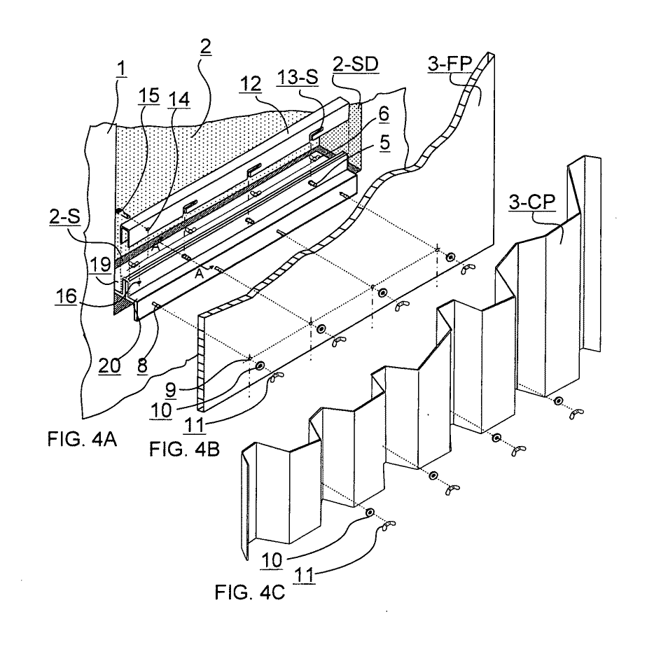

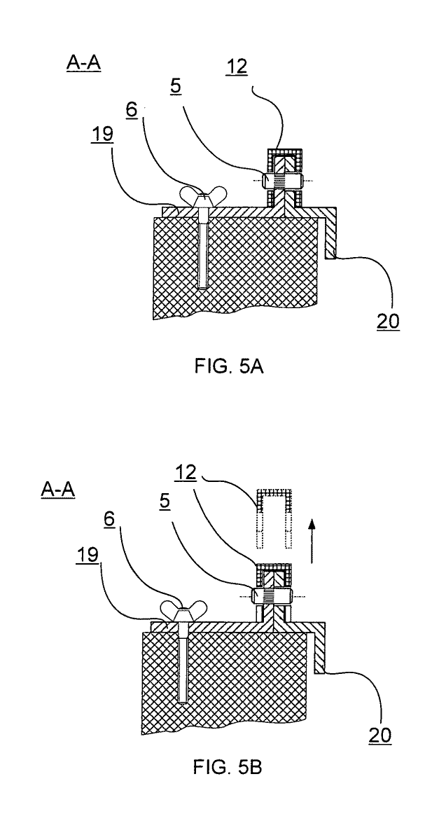

Referring now to FIGS. 4A-4C and FIGS. 5A-5B, another embodiment of a hurricane protection window guard having an emergency quick escape mechanism mounted over the window/door sill 2-S is illustrated. In this embodiment, the engaging wall member 19 is an elongated studded angle one side of each is mounted on the base 2-S and the other, the engaging part, having plurality of unthreaded studs 5 protruding from both sides of the engaging part with the stud length from both sides sufficient to engage both engaging parts and the side wall of the latching member bar, is parallel to the wall surface and has a locking aperture, the engaging shutter member 20 is an elongated Z-shaped/U-shaped bar. One side of each is fastened to the shutter panel 3-FP or 3-CP and the other with the locking aperture 16 and the plurality of holes of the size allowing the studs to be inserted and positioned so that both the wall 19 and shutter 20 engaging parts are coming into contact, the studs are protruded through the plurality of aligned holes in the shutter engaging member and the apertures of both engaging parts 16 and aperture of 14 of the latching member 12 are aligned. FIG. 4B is a prospective view of a flat shutter panel 3-FP applied to the embodiment of FIG. 4A. FIG. 4C is a prospective view of aligned vertically corrugated shutter panels 3-CP applied to the embodiment of FIG. 4A.

FIG. 5A is a cross-sectional view of the latching mechanism in a locked position taken along a line A-A of FIG. 4A. FIG. 5B is a cross-sectional view of the latching mechanism in an unlocked position taken along a line A-A of FIG. 4A.

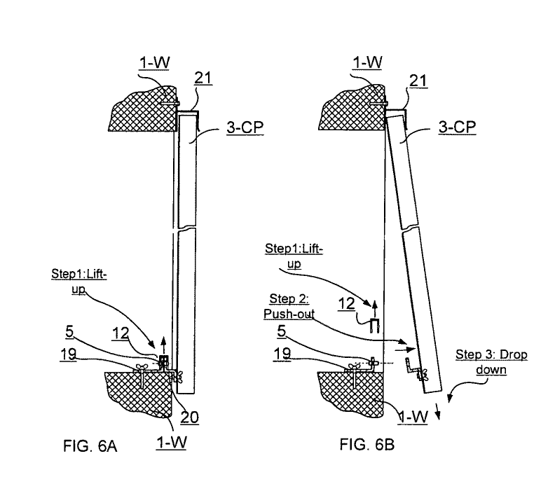

Turning now to FIGS. 6A-6B, cross-sectional views taken along a line A-A across the whole window/door opening of FIG. 4A are illustrated wherein the latching mechanism is in a locked position as shown in FIG. 6A and in an emergency open position as shown in FIG. 6B. In this configuration, the storm shutter assembly for building external opening with quick emergency escape mechanism comprises shutter panels 3-CP, a header member 21 having elongated configuration with open side of U-shape facing downward and mounted to a top base 1-W, and a footer member, which is of the present invention the quick emergency escape mechanism for a shutter assembly for building external opening, which is mounted on the bottom base 2-S, thus the escape mechanism is located within the window opening in the space between the window/door and the outside wall surface of a building. A method for activation of the quick emergency escape mechanism by people located inside of the building comprises the steps of a) removing the lock-pin 15 from the aperture of aligned engaging and latch members, b) sliding the latch member 12 towards the open position, c) lifting-up the latch member to unlatch the engaging members, and d) pushing-out the assembly of secured together shutter panels 3-CP and shutter engaging member 19 until the assembly is slipped down and the window opening is released for escaping out.

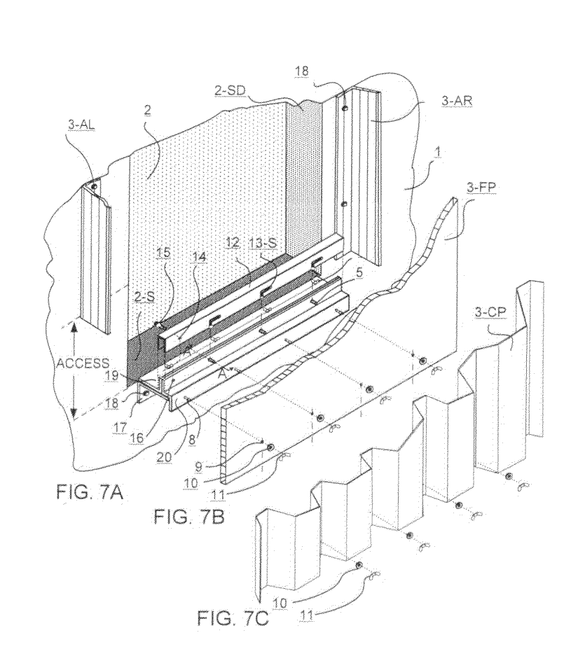

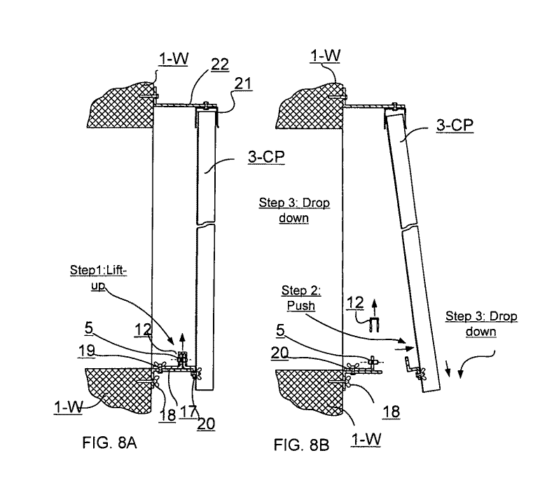

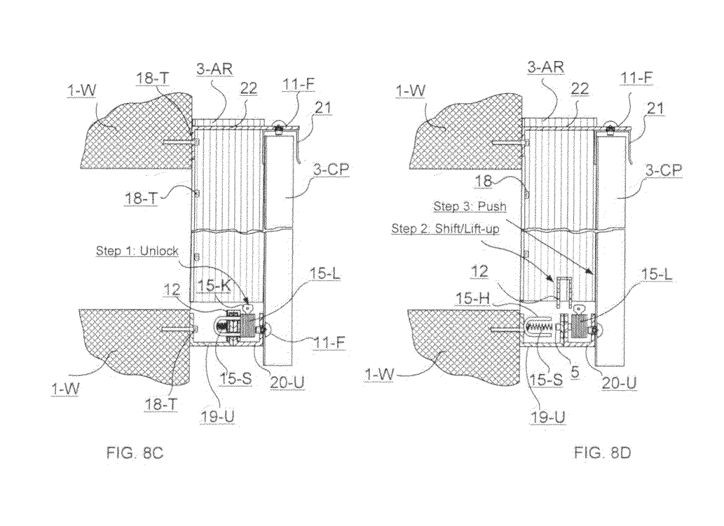

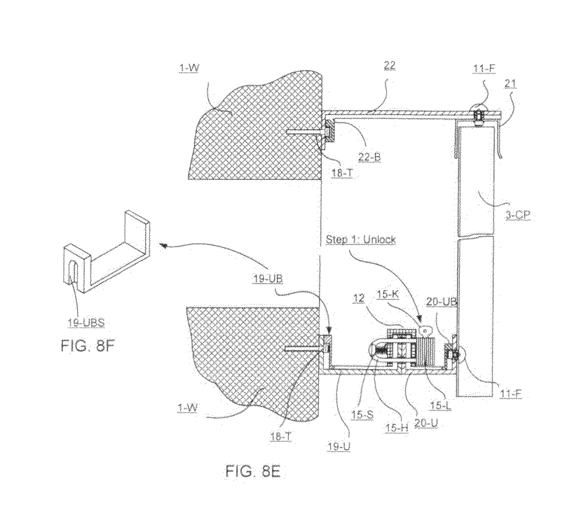

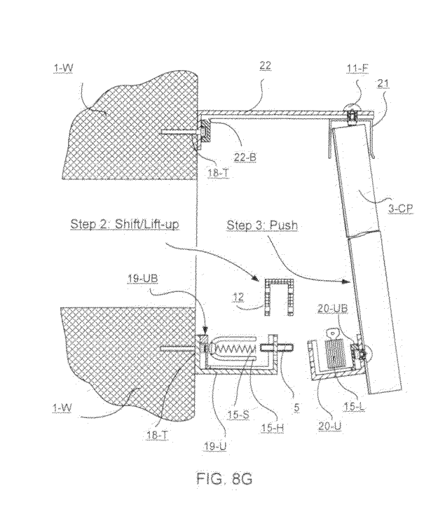

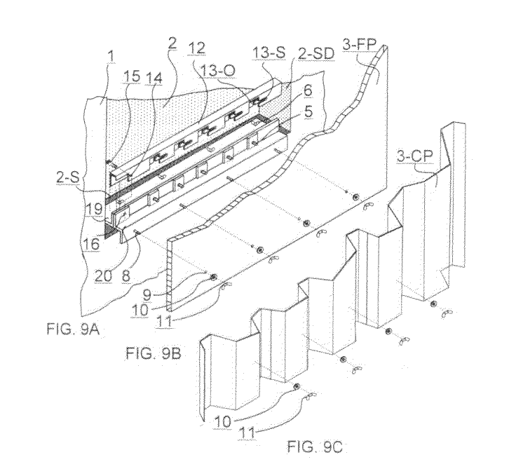

Referring more specifically to FIGS. 7A-7C and FIGS. 8A-8B, another embodiment of a hurricane protection window guard is shown having an emergency quick escape mechanism, which is similar to the described by FIGS. 4A-4C and FIGS. 6A-6B and is distinguished by its mounting over the extended angled mount 17 attached to the wall 1. The sides of the window/door opening are additionally protected from the wind and debris by side angles 3-AR and 3-AL that are aligned along the right and left sides of the window/door opening, respectively. It should be noted that the side of the opening where lock-pin, padlock, is located should have an uncovered area access, see FIG. 7A, for accessing by people from outside. The quick escape emergency mechanism is adapted to be activated by both people located inside of the building using the procedure described above and emergency personnel or other people located outside of the building.

The method comprises the steps of a) removing the lock-pin 15, which is accessible through the gap between shutters panels and the outside wall, from the apertures of aligned engaging 16 and latch 14 members; b) sliding the latch member 12 towards the open position; c) lifting-up the latch member 12 to unlatch the engaging members; and d) pulling-out the assembly of secured together shutter panels and shutter engaging member 3-CP/3-FP until the assembly is slipped down and the window opening is released for accessing by emergency personnel.

A modified form of locking arrangement equipped with a hurricane shutter escape mechanism is illustrated in FIGS. 8C-8D. This arrangement is similar to that described by FIGS. 7A-7C and FIGS. 8A-8B and is distinguished by using engaging U-profile elongated members 19-U and 20-U secured to the outside wall 1 next to the opening and shutter panels 3-CP, respectively, as well as by the replacement of both lock-pin 15 with padlock 15-L and all wing-nuts and regular screws with head flush bolts and tamper resistant screws, which provide additional prevention against gaining entrance to the premises. The padlock mechanism is equipped with the spring 15-S that allows a quick release of the hasp 15-H from the apertures of the engaged members.

Another variation of the locking arrangement equipped with a hurricane shutter escape mechanism allows removal of a conventional hurricane shutter from a window or door of a structure in the event of emergency, which can be activated from both inside and outside of the building opening, while keeping a security means installed at the outer side of the panel to preserve the installation against unauthorized removal of the panel to gain entrance to the premises is illustrated in FIGS. 8E-8G. The locking assembly of the present invention is utilized on the dwelling 1 in a combination with a hurricane shutter escape mechanism described by FIGS. 8C-8D. The enhanced protection against unauthorized removal of the panel is achieved by applying securing brackets 19-UB and 20-UB that hide both the wall and shutter fasteners. FIG. 8F is a perspective view of the securing bracket 19-UB having slot 19-UBS for hiding the wall fasteners 18-T. The brackets are secured by the latching elongated member 12 and can be removed only after the latch and engaging members are unlocked and the latching member is put in the released position. The top extended angled mount 22 is also equipped with protective brackets 22-B that hide the mounting screws 18-T. FIG. 8G is a cross-sectional view of the latching mechanism shown in FIG. 8E in an unlocked position.

FIGS. 9A-9C are a perspective views of another embodiment of the present storm shutter quick emergency escape mechanism mounted over the window/door sill 2-S wherein the engaging wall member 19 is an elongated studded angle, angled bar, one side of each is mounted on the base 2-S and the other, the engaging part, having a plurality of unthreaded studs 5 protruding from both sides of the engaging part with the stud length from both sides sufficient to engage both engaging parts and the side wall of the latching member bar 12, is parallel to the wall surface and has a locking aperture 14. The engaging shutter member 20 is an elongated Z-shaped/U-shaped bar one side of each is fastened to the shutter panel and the other with the locking aperture 16 and the plurality of sectional spaced along the length of the bar plates with a hole in each. The hole size allows the studs to be inserted and positioned so that both the wall 19 and shutter 20 engaging parts come into contact. The studs 5 protrude perspective through the plurality of aligned holes in the shutter engaging members and the aperture of both engaging parts are aligned. The sliding latch elongated member 12 is a U-shaped bar with the internal width between U-sides allowing the insertion of to come into contact with the wall 19 and shutter 20 engaging parts and fastening means in the form of elongated slots 13-S on the U-shaped bar sides, closed on the faced to the wall engaging member and open on the other bar side faced the shutter panel 3. The slot 13-O width allows studs 5 to be inserted and slide and open slots on the U-shaped bar, which is faced the shutter panel. The open slot width and height allow shutter sectional engaging parts to be inserted into the U-shaped bar and positioned so that open slot parts are aligned with the shutter engaging parts position. After shifting along the elongated part of the slots 13-O, the engaging members are fastened by the latching member 12 and are locked by a locking means 15 such as a pin or padlock inserted into aligned apertures of the latching member and the wall and shutter engaging members. FIG. 9B is a prospective view of a flat shutter panel applied to the embodiment of FIG. 9A. FIG. 9C is a perspective view of aligned vertically corrugated shutter panels applied to the embodiment of FIG. 9A.

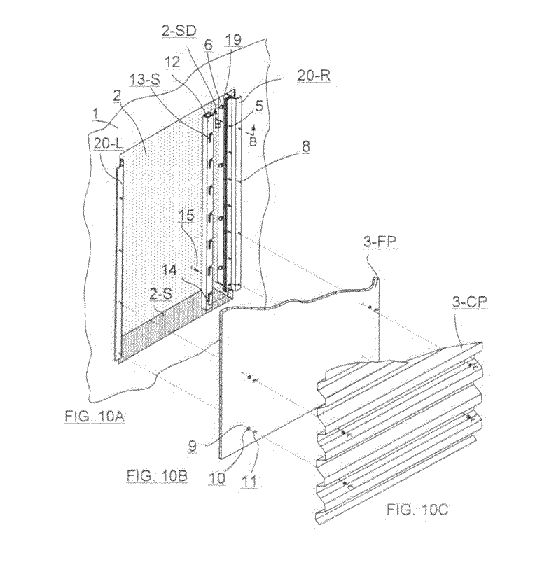

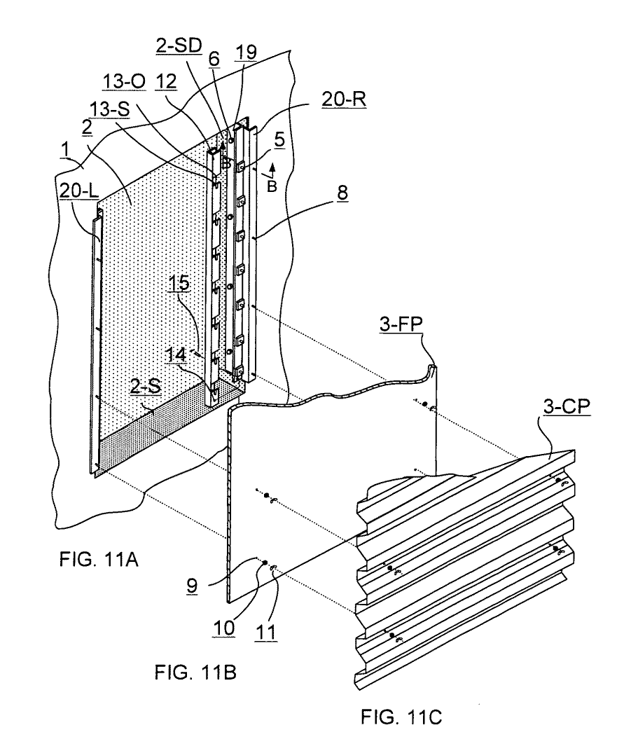

FIGS. 10A-10C are perspective views of another embodiment of the present storm shutter having a vertical quick emergency escape mechanism mounted over the left and right sides of the window/door opening 2, which is equipped with two contacting engaging elongated members 19 and 20 and a sliding removable latch member 12 for quick release of the shutter engaging elongated member secured to the shutter panel. The construction of the vertical emergency quick escape mechanism is similar to the construction of the horizontal quick emergency escape mechanism of FIG. 4A described above. FIG. 10B is a perspective view of a flat shutter panel applied to the embodiment of FIG. 10A. FIG. 10C is a perspective view of aligned horizontally corrugated shutter panels applied to the embodiment of FIG. 10A.

FIGS. 11A-110 illustrate another vertical version of the present storm shutter quick emergency escape mechanism mounted vertically over the left and right sides of the window/door opening 2, which is equipped with two contacting engaging elongated members 19 and 20 and sliding latch member 12 having cut openings for quick release of shutter engaging sectional parts of the elongated member 20 secured to a shutter panel. The construction of the vertical emergency quick escape mechanism is similar to the construction of the horizontal quick emergency escape mechanism of FIG. 7A described above. FIG. 11B is a perspective view of a flat shutter panel applied to the embodiment of FIG. 11A. FIG. 110 is a perspective view of aligned horizontally corrugated shutter panels applied to the embodiment of FIG. 11A.

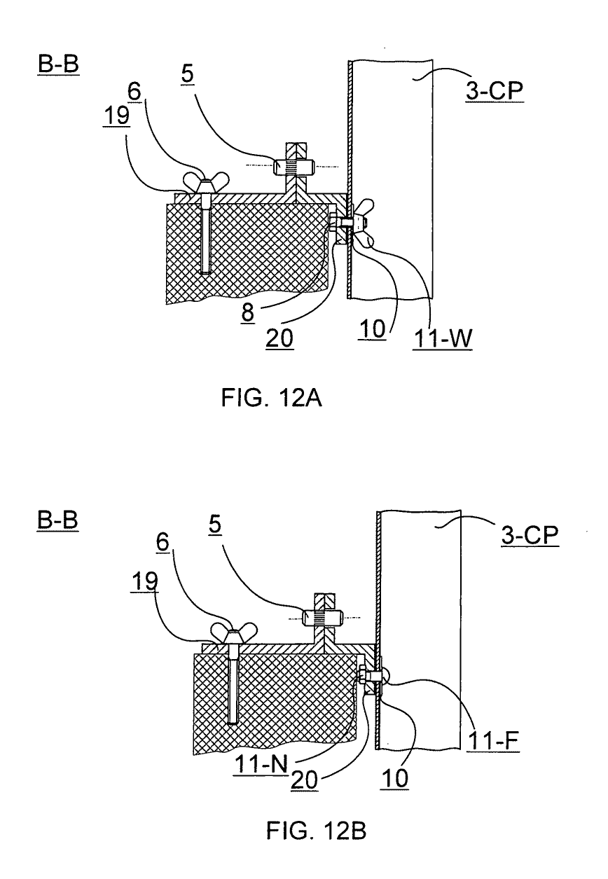

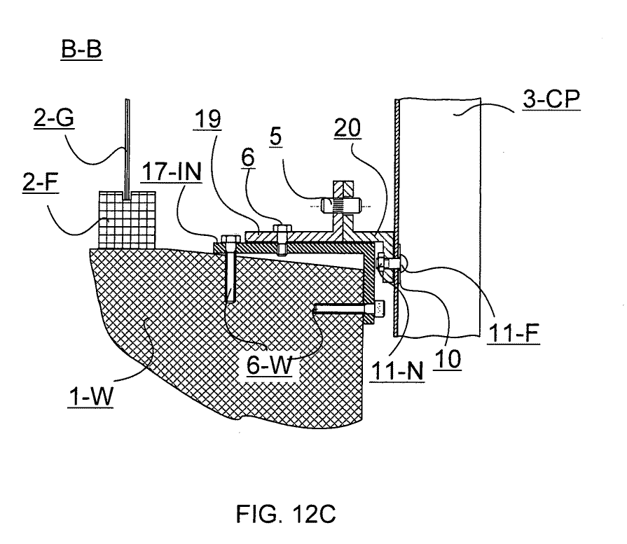

In the preferred embodiment, additional security is achieved by replacement of wing-nut fasteners 11-W, which are widely used for hurricane shutter assemblies, with the burglary preventive permanent fasteners 11-F such as a flush lever, as shown by FIG. 12A and FIG. 12B.

FIG. 12C shows a typical cross-sectional view of the latching mechanism installed on an angled base 17, which allows mounting a latching mechanism on a side of a window opening that is not straight against an outside wall of the building.

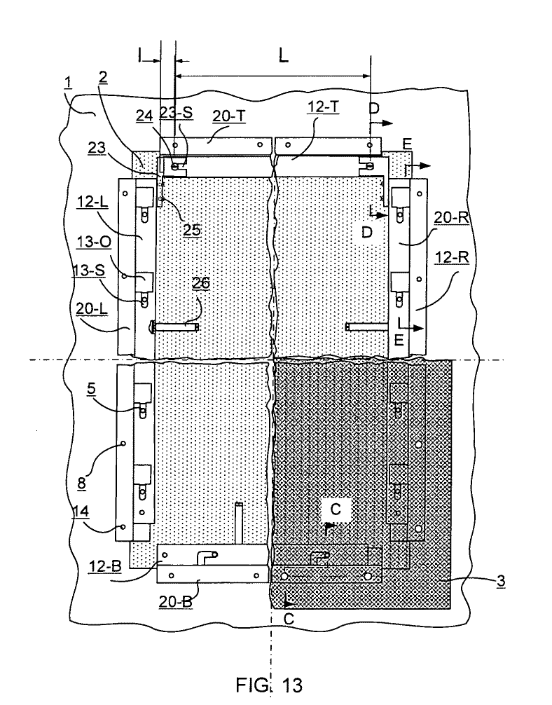

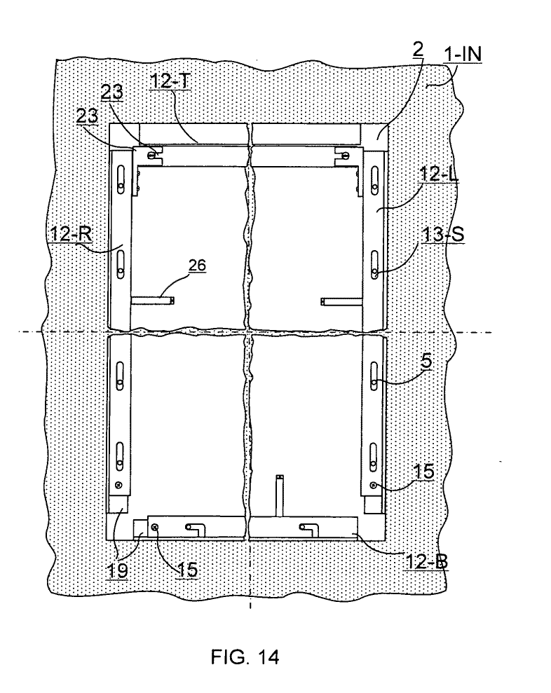

A modified improved form of the present invention embodiment is shown in FIGS. 13 and 14. FIG. 13 is an outside front view, locked position. FIG. 14 is an inside front view, locked position. In this modification, the guard shutter assembly units with quick emergency escape mechanism are mounted over all four sides of the window/door opening. Each side of the opening is equipped with a coming into contact engaging elongated coupled member, with two of them, side members with a fork-lift flange 23 having horizontal slot 23-S on each their top side for lifting and latching the top latching removable member 12-T and keeping it in a aligned position allowing to slide across the engaging parts of the header latching member, left 19-L and 20-L and right 19-R and 20-R, that are latched by sliding members 12-L and 12-R, respectively, having cut openings for quick release of shutter engaging sectional parts of the elongated member secured to a shutter panel 20-L and 20-R, similar to shown in FIG. 11, with the third one on the bottom, footer member, latched by sliding removable latch member 12-B similar to shown in FIG. 4, and with the fourth one on the top, header member, latched by removable latch member 12-T. The header member is equipped with an engaging sliding removable member 12-T with pivot studs 24 fastened to its left and right ends and having the outer diameter allowing them to be inserted into the slot 23-S of the fork-lift flange 23, which is slid across the length of the latching member.

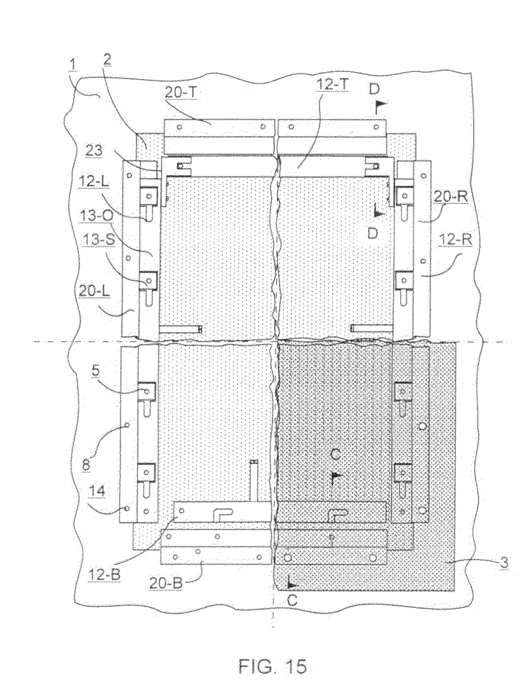

FIG. 15 is an outside front view of the embodiment of the present guard shutter assembly with quick emergency escape mechanism shown in FIG. 13, which is in an unlocked position.

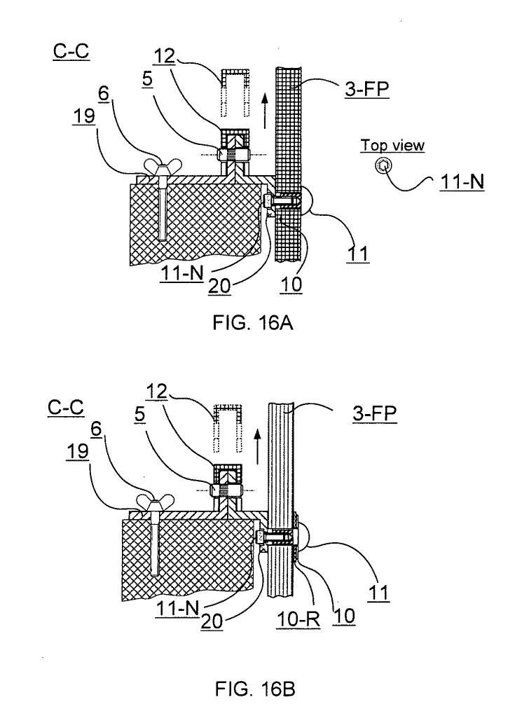

FIG. 16A is a cross-sectional view of the latching mechanism with a flat shutter panel fastened by burglary preventive permanent fasteners such as a combination of a flush lever nut and a tamper resistant screw taken along a line C-C of FIG. 13 in a locked position.

FIG. 16B is a cross-sectional view of the latching mechanism with a transparent/translucent flat shutter panel fastened by burglary preventive permanent fasteners such as a combination of a flush lever nut and a tamper-resistant screw taken along line C-C of FIG. 16 in an unlocked position.

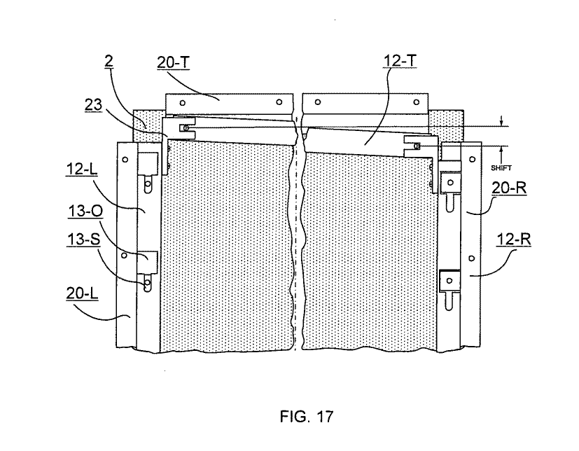

FIG. 17 is an outside front view of the top portion of the embodiment of the present guard shutter assembly with quick emergency escape mechanism, which is in a locked position on the left side, similar to FIG. 13, and in an unlocked position on the right side, similar to FIG. 15. This figure shows the importance of keeping a proper tolerance TOL, which is the minimum gap size between the top of the removable latch member 12-T and the bottom of the bases of engaging members 19-T and 20-T when both sides of the assembly is in a locked position. It can be achieved by maintaining a proper geometry relationship between the shape and dimensions of the assembly that includes position of pivot studs 24 and distance L between them relative to the geometry of the removable latch member 12-T as well as the shape of the fork-lift flange. In fact, the tolerance TOL should be kept by such a way that allows maintaining one side of the window opening assembly in a locked and the other in the unlocked positions. It can be achieved by a proper procedure for assembling, which comprises the steps of
coupling the wall 19-T and shutter 20-T engaging members of the header member by an auxiliary screws or a sticky tape,
fastening the wall engaging member 19-T to the inner top surface of the opening using screws 6 keeping in mind that the surface of the shutter engaging member 20-T facing the shutter is positioned within the flat surface formed by outer edges of the opening,
assembling side members that includes mounting a fork-lift flange 23 to the corresponding latch slide 12 side member followed by latching one of the side members in a locked and the other in unlocked positions,
inserting pivot studs 24 into the slots 23-S of corresponding fork-lift flanges and moving the assembly for mounting to the inner side wall of the opening,
fastening by screws 6 to the wall the locked wall side member 12 maintaining the minimum tolerance TOL-min between the top corner of the removable top member 12_T and the bottom of both the wall 19-T and shutter 20-T engaging members of the top member while keeping the other side member in the lower position,
switching the positions of the locked and unlocked side members and fastening by screws 6 to the wall the locked side member while maintaining the minimum tolerance between the top corner of the removable top member 12-T and the bottom of both the wall and shutter engaging members of the top member,
assembling the bottom, footer member, by latching wall 19-B and shutter 20-B members in a locked position,
fastening the wall engaging member 19-B to the inner bottom surface of the opening using screws 6 keeping in mind that the surface of the shutter engaging member 20-B facing shutter is positioned within the flat surface formed by outer edges of the opening,
making a template with the position for the holes in the shutter panel for the whole building opening,
positioning the template on the shutter 3 panel and making proper holes,
unlocking all shutter engaging members and removing from the assemblies,
fastening them in the proper position to the shutter panel,
engaging the shutter assembly into the window opening and latching first top and side members by sliding left and right latching members towards the top latch member,
locking left and right members by inserting a pin into aligned apertures of engaging and latching members, and
sliding and locking the bottom latch member.

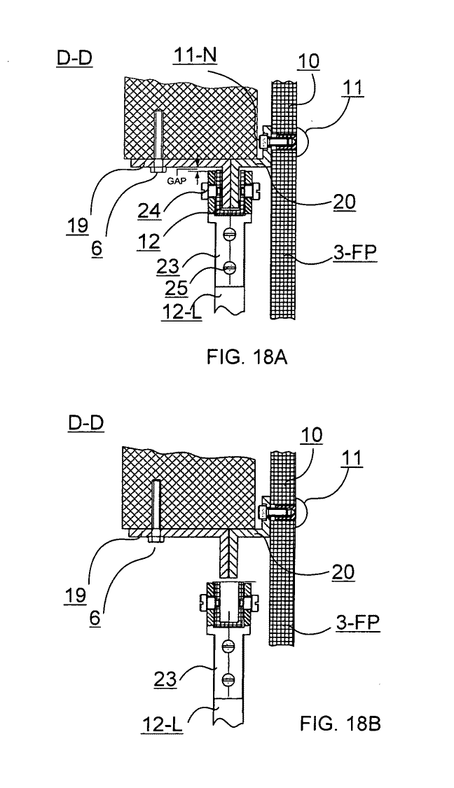

FIG. 18A is a cross-sectional view of the latching mechanism with a flat shutter panel fastened by improved burglary preventive permanent fasteners such as a combination of a flush lever nut and a tamper resistant screw taken along a line D-D of FIG. 13 in a locked position.

FIG. 18B is a cross-sectional view of the latching mechanism with a transparent/translucent flat shutter panel fastened by burglary preventive permanent fasteners such as a combination of a flush lever nut and a tamper-resistant screw taken along line D-D of FIG. 15 in an unlocked position.

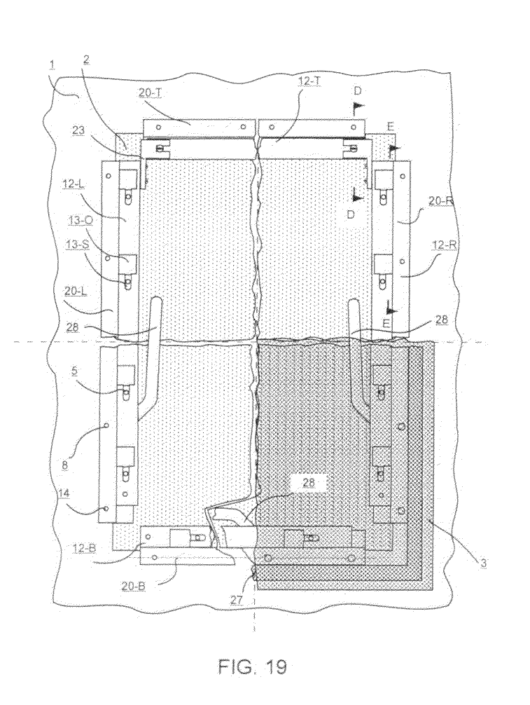

Another embodiment is shown in FIGS. 19-24B. In this embodiment, a guard shutter assembly with weather-tight and/or water-tight sealing around the window/door opening accompanied by additional thermal insulation qualities, burglary protection, and quick emergency escape mechanism is illustrated. The closure shown in FIG. 19 is mounted over all four sides of the window/door opening and comprises:
a shutter panel 3 equipped with a sealing gasket 27 around the periphery of the shutter panel,
a wall header member 19-T, two wall side members 19-L and 19-R, and wall footer member 19-B are engaged with the corresponding engaging shutter members 20-T, 20-L, 20-R, and 20-B and capable to be shifted toward each other while the latch member 12 is slid from open/unlocked to the fastened/locked position providing compression to the seal 27,
side slide members with fork-lift flanges 23 having horizontal slots 23-S on each of their top sides for lifting and latching the top latch member 12-T and keeping it in a aligned position allowing to slide across the engaging parts of the side member, thus providing compression to the seal 27,
a footer member that is equipped with an engaging sliding member 12-B that is slid along the length of a latching member, thus providing compression to the seal 27.
   The guard shutter assembly with weather-tight and/or water-tight sealing around the window/door opening is constructed of different flat sheet material which is dependent of the application. Bullet-resistant transparent/translucent materials, such as polycarbonate or Lexan plastic, are especially suitable in weather-tight and water-tight applications

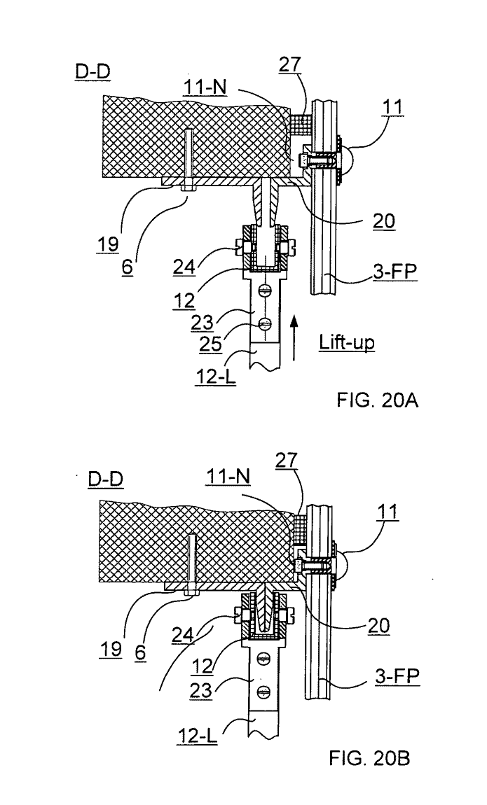

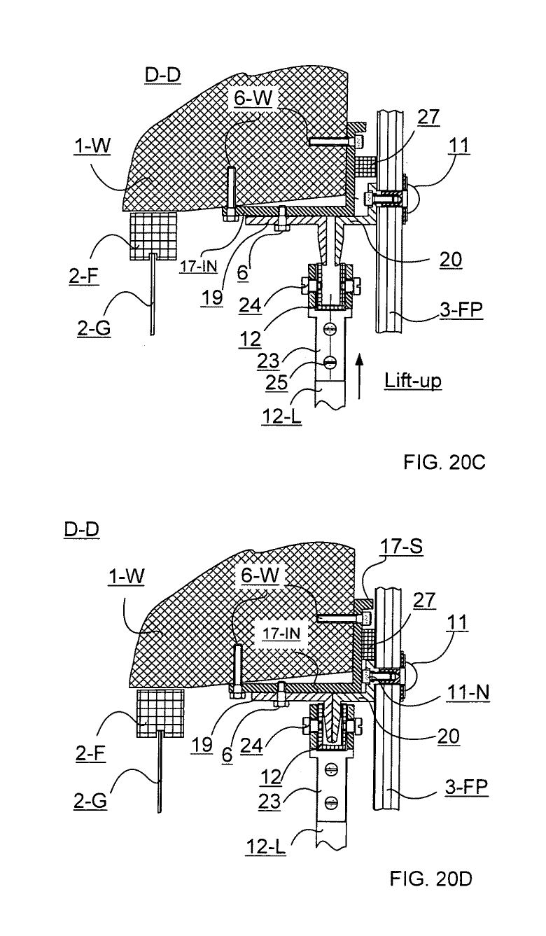

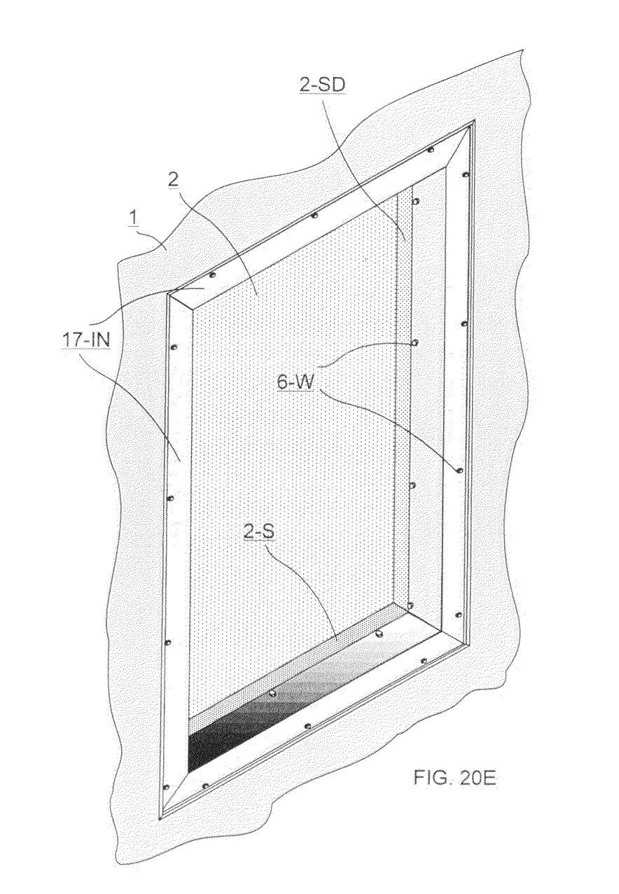

FIG. 20A is a cross-sectional view of the top latching mechanism in an unlocked/unsealed position, which is taken along a line D-D of FIG. 19.

FIG. 20B is a cross-sectional view of the top latching mechanism in a locked/sealed position which is taken along a line D-D of FIG. 19.

FIG. 20C is a cross-sectional view of the top latching mechanism installed on an angled base 17 which is mounted on the top sill of the window/door opening that is not straight against an outside wall of the building in an unlocked/unsealed position, which is taken along a line D-D of FIG. 19.

FIG. 20D is a cross-sectional view of the top latching mechanism as of FIG. 20C in a locked/sealed position, which is taken along a line D-D of FIG. 19.

FIG. 20E is a prospective view of a window/door opening with angled bases 17 on all sides of the opening; which are mounted on the window/door sills and sides that are not straight against an outside wall of the building, for mounting the latching assemblies as well as for better sealing of the window opening in a locked position, which also can function as a decorative frame around the opening.

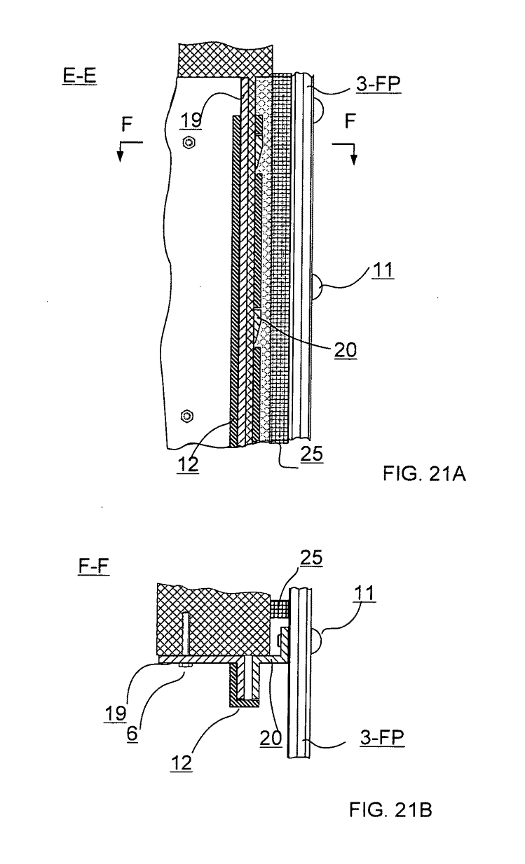

FIG. 21A is a cross-sectional view of the side, right, latching mechanism in an unlocked/unsealed position, which is taken along line E-E of FIG. 19.

FIG. 21B is a cross-sectional view of the side, right, latching mechanism in an unlocked/unsealed position, which is taken along line F-F of FIG. 21A.

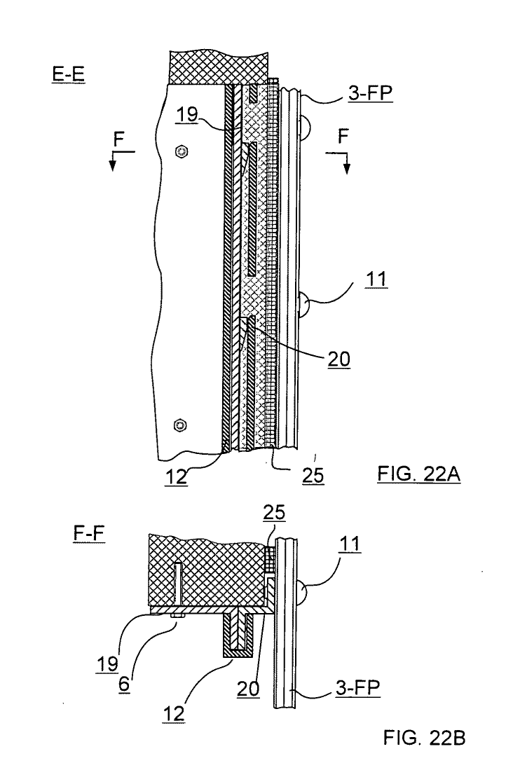

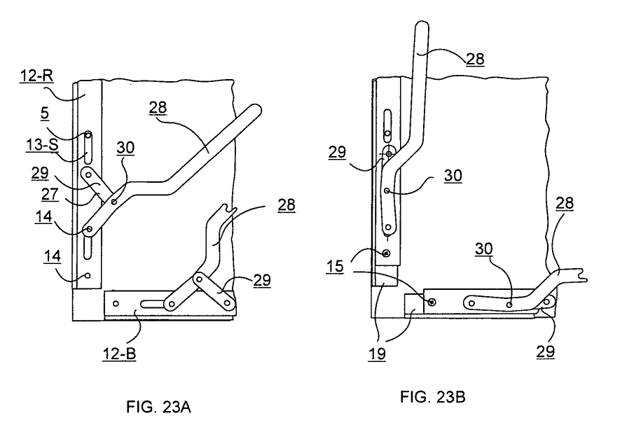

FIG. 22A is a cross-sectional view of the side, right, latching mechanism in a locked/sealed position, which is taken along a line E-E of FIG. 19.

FIG. 22B is a cross-sectional view of the side, right, latching mechanism in a locked/sealed position, which is taken along a line F-F of FIG. 22A.

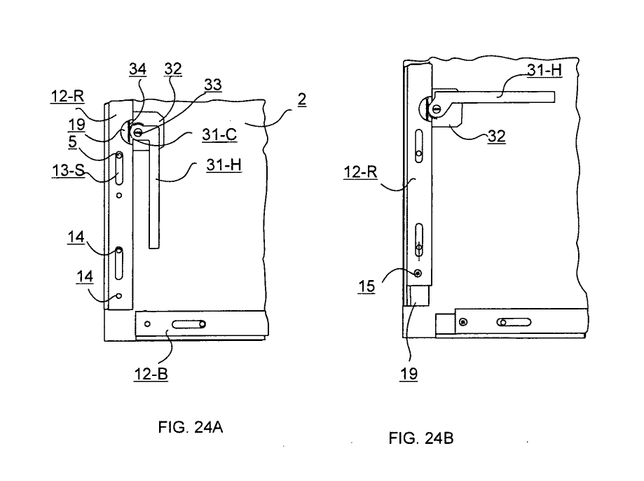

Sliding the latch member results in the seal compression and requires applying an additional force, which may be significant for an ordinary person. Therefore, in the preferred embodiment, decrease of applied force by inhabitants has been achieved by application of both a latch gear assembly, shown in FIGS. 23A-23B, and a latch cam gear assembly, shown in FIGS. 24A-24B.

LIST OF REFERENCE NUMBERS

| | |
|---|---|
| 1 | outer wall surface of the building structure 1-W |
| 1-IN | inner wall surface of the building structure 1-W |
| 1-W | building wall |
| 2 | window or door opening in the building |
| 2-S | sill of window/door opening |
| 2-SD | side of the window/door opening |
| 2-F | glazing frame |
| 2-G | existing glazing |
| 3 | shutter panel |
| 3-FP | flat shutter panel |
| 3-CP | corrugated shutter panel |
| 3-AR | side angle aligned along the right side of the window/door opening |
| 3-AL | side angle aligned along the left side of the window/door opening |
| 4 | engaging angled sectional member secured to a sill/side of the opening |
| 5 | unthreaded stud in 4 for keeping |
| 6 | bolt anchor for securing engaging member 4 to the base member |
| 6-W | bolt anchor for securing base member 17-IN to the sill/side of the opening |
| 7 | shutter engaging sectional member secured to the shutter panel |
| 8 | threaded stud in 7 for securing a shutter panel through 9 using 10 and 11 |
| 9 | mounting hole in a shutter panel |
| 10 | nut washer |
| 11-W | wing nut |
| 11-F | head flush bolt, permanent fastener |
| 11-N | tamper resistant screw |
| 12 | latch member for coupling opening 4 and shutter 7 engaging members |
| 12-L | left latch member |
| 12-R | right latch member |
| 12-T | top latch member |
| 12-B | bottom latch member |
| 13 | open elongated slot in latch member 12 for securing latch member in a locked |
| | position |
| 13-S | closed elongated slot in latch member 12 for sliding securing latch member |
| | between locked and unlocked positions |
| 13-O | opening in latch member 12 for releasing shutter engaging member 7 in unlocked |
| | position |
| 14 | aperture in the latch member 12 |
| 15 | pin for inserting into aligned apertures to lock aligned engaging and latch |
| | members in a locked position |
| 15-H | hasp of the padlock for inserting into aligned apertures to lock aligned engaging |
| | and latch members in a locked position |
| 15-L | padlock |
| 15-K | key of the padlock |
| 15-S | spring coil to release the hasp frm the aperture of the locked members |
| 16 | aperture in the engaging angled sectional member 4 |
| 17 | extended angled mount to the outer wall 1 of the building |
| 17-IN | angled mount fastened to a sill/side of the building opening to maintain straight |
| | angle between the base and the building outer wall, which is required for mounting |
| | the wall engaging member of the embodiment of present invention security ledge in |
| 17-S | 17-IN to prevent unauthorized access to the mounting fasteners |
| 18 | bolt anchor for securing mounts to the outer wall 1 as well as to the wall 2 within |
| | the window/door opening |
| 18-T | tamper-resistant bolt anchor for securing mounts to the outer wall 1 as well as to |
| | the wall 2 within the window/door opening |
| 19 | engaging angled elongated member secured to a sill/side of the opening |
| 19-U | engaging U-profile elongated member secured to an outside wall next to the |
| | opening |
| 19-UB | securing bracket to cap bolt anchors 18 and/or 18-T, thus preventing unauthorized |
| | access for disassembling |
| 19-UBS | slot in the securing bracket 19-UB |
| 20 | engaging Z-shaped elongated member secured to a shutter panel |
| 20-R | engaging Z-shaped elongated member secured to a shutter panel located on the |
| | right side of the window/door opening |
| 20-L | engaging Z-shaped elongated member secured to a shutter panel located on the |
| | left side of the window/door opening |
| 20-U | engaging U-shaped elongated member secured to a shutter panel |
| 20-UB | securing bracket to hide shutter fasteners, thus preventing unauthorized access for |
| | disassembling |
| 21-H | h-header mounted to the outer wall over the window/door opening of the building |
| 21-U | u-header mounted to the angled mount 22 |
| 22 | extended angled mount to the outer wall over the window/door opening of the |
| | building |
| 22-B | securing bracket to cap bolt anchors 18 and/or 18-T used for mounting extended |
| | mount 22, thus preventing unauthorized access for disassembling |
| 23 | fork-lift flange with horizontal slot 23-S fastened to left and right latch members 12-L |
| | 12-R, respectively, for lifting top latch member 12-T through the mounted on it pivot |
| | studs |
| 23-S | horizontal slot in fork-lift flange |
| 24 | pivot studs fastened to the top latch member on its left and right ends |
| 25 | screws for fastening fork-lift flanges to the top ends of right latch members 12-L 12-R |
| 26 | handle mounted on latch member 12 for its sliding and lifting |
| 27 | seal gasket on the periphery of the shutter panel |
| 28 | latch gear handle |
| 29 | movable leg of the latch gear |
| 30 | pivot point |
| 31-C | cam pivotally mounted through pivot point (bolt) 33 there between plate 32 fastened |
| 31-H | to the latch member 12 and engaging elongated member19 |
| 32 | plate fastened to the latch member 12 |
| 33 | pivot point (bolt) |
| 34 | gear teeth of the cam 31 |
| 35 | gear teeth of the elongated member 19 |

### Overview

The present examples and descriptions should be considered as illustrative and not restrictive, and the invention is not to be limited to the details given herein but may be modified within the scope of the appended claims. Particularly, bulletproof shield assemblies, including relatively heavy structures, equipped with a quick emergency escape mechanism of the present invention can be used efficiently in a variety of military and security applications where “Immediate Action Rapid Deployment” may be utilized.

What is claimed is:

1. A quick emergency escape mechanism for a shutter assembly for a building external opening comprising:
an engaging wall member adapted to be secured to a base coupled to a building structure in the vicinity of a building opening, the engaging wall member including an engaging part and a part for securing to the building structure;
an engaging shutter member adapted to be secured to a shutter panel, the engaging shutter member including an engaging part and a securing part for securing to a shutter panel; and
an engaging sliding latch member for fastening and locking the engaging parts of the wall and shutter members, the sliding latch member including fastening means and locking means.

2. The quick emergency escape mechanism for a shutter assembly for a building external opening as set forth in claim 1 wherein the sliding latch member is equipped with at least one handle for its easy sliding and lifting.

3. The quick emergency escape mechanism for a shutter assembly for a building external opening as set forth in claim 1 wherein at least one of the engaging parts is positioned by such a way that an engaging shutter member is shifted towards the building when the latch member is slid from open/unlocked to the fastened/locked position.

4. The quick emergency escape mechanism for a shutter assembly for a building external opening as set forth in claim 3 wherein the sliding latch member is equipped with at least one gear mechanism for its easy sliding and for tighten a shutter panel to the building wall.

5. The quick emergency escape mechanism for a shutter assembly for a building external opening as set forth in claim 4 wherein the gear mechanism is a latch handle adapted to be pivotally mounted to both the wall engaging member and the latch member in such a way that relative displacement of the latch handle affects forward and backward sliding motion along the latch member.

6. The quick emergency escape mechanism for a shutter assembly for a building external opening as set forth in claim 4 wherein the gear mechanism is a cam extending from the cam elongated handle and with a plurality of peripherally disposed gear teeth, the cam being pivotally mounted to the latching member for selectively inter-engaging gear teeth longitudinally disposed along a part of the top section of the engaging wall member so that relative displacement of the elongated handle affects the cam rotation resulting in forward and backward sliding motion along the latch member.

7. The quick emergency escape mechanism for a shutter assembly for a building external opening as set forth in claim 1 wherein the engaging wall member includes a plurality of aligned sectional angles, each angle having two sides, one side of each angle being mounted on the base and the other side of each angle having a stud facing interiorly with the window/door opening being parallel to the wall surface, and wherein the engaging shutter member is a plurality of sectional aligned Z-shapes/U-shapes, the length of each shape being less than the distance between adjacent wall members and one side of each shape is adapted to be fastened to a shutter panel within the space between adjacent engaging wall members and the other is parallel to the wall surface, the plurality of both engaging parts being overlapped in a locked position.

8. The quick emergency escape mechanism for a shutter assembly for a building external opening as set forth in claim 7 wherein the removable sliding latch elongated member is of a rectangular/U-shaped cross-section with a width equal to the distance between overlapped engaging parts and wherein the fastening means is in the form of open slots with each slot having a width allowing studs to be inserted and with an elongated part along the length of the latching member with open parts across the latch member and positioned so that open slot parts are aligned with the stud position whereby the studs can be inserted into the slots, and the locking means being in the form of aperture adapted to be inserted into the overlapped gap so that the studs are inserted into open slots and after the shifting along the elongated part of the slots the engaging members are fastened by the latching member and are locked by a locking means inserted into aligned apertures of the latching member and the base.

9. The quick emergency escape mechanism for a shutter assembly for a building external opening as set forth in claim 7 wherein the sliding latch elongated member is a U-shaped bar with an outer width equal to the distance between overlapped engaging parts and with fastening means in the form of elongated closed slots with the slots having a width allowing studs to be inserted and slide, and further including an open slot on both sides of the latch elongated member with the open slots having a width and height allowing the shutter engaging parts to be inserted through the U-shaped bar and positioned so that open slots are aligned with the shutter engaging parts position, and wherein the locking means is in the form of an aperture adapted to be inserted into the overlapped gap so that the studs are inserted into elongated slots and, after the shifting along the elongated part of the slots, the engaging members are fastened by the latching member and are locked by a locking means inserted into aligned apertures of the latching member and the base.

10. The quick emergency escape mechanism for a shutter assembly for a building external opening as set forth in claim 1 wherein the engaging wall member is an elongated studded angle with two sides, one side of each angle adapted to be mounted on the base and the other side being an engaging part having a plurality of unthreaded studs protruding from both sides of the engaging part, the studs having a length from both sides sufficient to engage both engaging parts, the side wall of the latching member bar being parallel to the wall surface and having a locking aperture, the engaging shutter member being an elongated Z-shaped/U-shaped bar with two sides, one side of each bar being fastened to the shutter panel and the other side with the locking aperture and the plurality of holes of the size allowing the studs to be inserted and positioned so that both the wall and shutter engaging parts are brought into contact, the studs adapted to protrude through the plurality of aligned holes in the shutter engaging member and the aperture of both engaging parts are aligned.

11. The quick emergency escape mechanism for a shutter assembly for a building external opening as set forth in claim 10 wherein the removable sliding latch is a U-shaped bar with an internal width between the sides of the U-shaped bar for allowing contact with the wall and the shutter engaging parts, and wherein the fastening means is in the form of the plurality of open slots with a slot width allowing the studs to be inserted into the slots and with open parts across the latch member positioned so that open slot parts are aligned with the stud position and studs can be inserted into the slots, and the locking means being in the form of aperture for contacting a shutter and wall engaging parts whereby when the studs are inserted into open slots and after the shifting along the elongated part of the slots the engaging members are fastened by the latching member and are locked by a locking means inserted into aligned apertures of the latching member and the wall and shutter engaging members.

12. The quick emergency escape mechanism for a shutter assembly for a building external opening as set forth in claim 1 wherein the engaging wall member is an elongated studded angle bar with two sides, one side of each angle bar is mounted on the base and the other side being an engaging part having a plurality of unthreaded studs protruding from both sides of the engaging part, the studs having a length from both sides sufficient to engage both the engaging parts and the side wall of the latching member bar, the latching member bar being parallel to the wall surface and having a locking aperture, the engaging shutter member being an elongated Z-shaped/U-shaped bar with two sides, one side of each bar being fastened to the shutter panel and the other side of each bar having a locking apertures spaced along the length of the bar with a hole, the hole having a size allowing the studs to be inserted and positioned so that both the wall and shutter engaging parts are adapted to come into contact with the studs protruded through the plurality of aligned holes in the shutter engaging member and the aperture of both engaging parts are aligned.

13. The quick emergency escape mechanism for a shutter assembly for a building external opening as set forth in claim 12 wherein the sliding latch elongated member is a U-shaped bar with the internal width between U-sides allowing contact between the wall and shutter engaging parts, the fastening means being in the form of elongated slots on the U-shaped bar sides, closed on the side facing the wall engaging member and open on the side facing the shutter panel, the slots having a width allowing studs to be inserted and slid, the open slots on the U-shaped bar facing the shutter panel, the open slot having a width and a height allowing shutter parts to be inserted into the U-shaped bar and positioned so that open slot parts are aligned with the shutter engaging parts position after the shifting along the elongated part of the slots, the engaging members are adapted to be fastened by the latching member and locked by a locking means inserted into aligned apertures of the latching member and the wall and shutter engaging members.

14. The quick emergency escape mechanism for a shutter assembly for a building external opening as set forth in claim 3 wherein the engaging wall member is an elongated studded angle bar, the angle bar having two sides, one side of each bar being mounted on the base and the other side, the engaging part, having a plurality of unthreaded studs protruding from both sides of the engaging part, the stud having a length from both sides sufficient to engage both engaging parts and the side wall of the latching member bar, the latching member bar being parallel to the wall surface and having a locking aperture, the engaging shutter member is an elongated Z-shaped/U-shaped bar with two sides, one side of each bar is fastened to the shutter panel and the other side formed with locking apertures spaced along the length of the bar plates with a hole in each bar plate, the hole having a size allowing the studs to be inserted and positioned so that both the wall and shutter engaging parts are coming into contact, the cross-sectional shape of the bar plates being modified whereby only the surface coming into contact with the latching bar surface is milled to make variable thicknesses from lower to the higher along the sliding direction from the open to the locked positions, the studs being protruded through the plurality of aligned holes in the shutter engaging member and the aperture of both engaging parts being aligned.

15. The quick emergency escape mechanism for a shutter assembly for a building external opening as set forth in claim 14 wherein the sliding latch elongated member is a U-shaped bar with the internal width between U-sides allowing contact between the wall and shutter engaging parts, fastening means in the form of elongated slots on the U-shaped bar sides, one bar side being closed facing the wall engaging member, the other side being open facing the shutter panel, the bar having a slot with a width allowing studs to be inserted and slid, open slots on the U-shaped bar side faced the shutter panel, the open slots having a width and height allowing shutter engaging parts to be inserted into the U-shaped bar and positioned so that open slot parts are aligned with the shutter engaging parts after shifting along the elongated part of the slots the shutter engaging member is shifted towards the building wall and the engaging members are fastened by the latching member and are locked by a locking means inserted into aligned apertures of the latching member and the wall and shutter engaging members.

16. The quick emergency escape mechanism for a shutter assembly for a building external opening as set forth in claim 1 wherein the engaging wall member is an elongated angle with two sides, one side of each wall member adapted to be mounted on the base and the other side, the engaging part, is parallel to a wall surface, the engaging shutter member being an elongated Z-shaped/U-shaped bar, one side of each wall member being fastened to the shutter panel and the other side, the engaging part, is in contact with the engaging part of the wall member.

17. The quick emergency escape mechanism for a shutter assembly for building external opening as set forth in claim 16 wherein the removable sliding latch elongated member is a U-shaped bar with an internal width between U-sides allowing the insertion of coming into contact the wall and shutter engaging parts.

18. The quick emergency escape mechanism for a shutter assembly for a building external opening as set forth in claim 16 wherein both the wall and shutter engaging parts are in contact and the cross-sectional shape of both engaging parts is modified by such a way whereby only the surface coming into contact with the latching bar surface is milled to make variable thickness from a lower location to a higher location along the sliding direction from the open to the locked positions, and the aperture of both engaging parts are aligned.

19. The quick emergency escape mechanism for a shutter assembly for a building external opening as set forth in claim 18 wherein the sliding latch member is removable and the U-shaped bar has an internal width between U-sides allowing contact between the wall and shutter engaging parts, and wherein the locking means includes apertures, is put over coming into contact shutter and wall engaging parts by straight sliding toward the basis of the engaging parts so that the shutter engaging member is shifted towards the building.

20. The quick emergency escape mechanism for a shutter assembly for a building external opening as set forth in claim 1 wherein at least one of the engaging parts is positioned whereby the engaging shutter member is shifted towards the building when the latch member is slid from open/unlocked to the fastened/locked position.

21. A storm shutter assembly for a building external opening with a quick emergency escape mechanism comprising:
a shutter panel;
a header member having elongated configuration with open side in a U-shaped configuration facing downward and mounted to a top base;
a footer member with an emergency escape mechanism for a shutter assembly for a building external opening, which is mounted on a bottom base;
an engaging wall member adapted to be secured to a base coupled to a building structure in the vicinity of a building opening, the engaging wall member including an engaging part and a part for securing to the building structure;
an engaging shutter member adapted to be secured to a shutter panel, the engaging shutter member including an engaging part and a securing part for securing to a shutter panel; and
an engaging sliding latch member for fastening and locking the engaging parts of the wall and shutter members, the sliding latch member including fastening means and locking means.

22. The storm shutter assembly with quick emergency escape mechanism for a building external opening comprising as set forth in claim 21 wherein the bottom base is a window/door sill and the top base is the external wall of the building, thus the escape mechanism is located within the window opening in the space between the window/door and the outside wall surface of a building.

23. The storm shutter assembly with quick emergency escape mechanism for a building external opening comprising as set forth in claim 22 wherein the shutter panel includes a plurality of corrugated shutter overlapped panels aligned vertically.

24. The storm shutter assembly for a building external opening with quick emergency escape as set forth in claim 21 wherein both the top and bottom bases are extended angled elongated mounts to the outer wall of the building, thus the escape mechanism is located outside the window opening in the space between the outside wall surface of a building and the inner shutter panel surface allowing an access to the locking means and the latching mechanism for people from both inside and outside of the building.

25. The storm shutter assembly with quick emergency escape mechanism for a building external opening comprising as set forth in claim 21 wherein the bottom base is a window/door sill and the top base is the external wall of the building, thus the escape mechanism is located within the window opening in the space between the window/door and the outside wall surface of a building.

26. The storm shutter assembly with quick emergency escape mechanism for a building external opening comprising as set forth in claim 21 wherein the shutter panel includes a plurality of corrugated shutter overlapped panels aligned vertically.

27. The storm shutter assembly for a building external opening with quick emergency escape mechanism comprising as set forth in claim 21 wherein both the top and bottom bases are extended angled elongated mounts to the outer wall of the building, thus the escape mechanism is located outside the window opening in the space between the outside wall surface of a building and the inner shutter panel surface allowing an access to the locking means and the latching mechanism for people from both inside and outside of the building.

28. The storm shutter assembly for building external opening with quick emergency escape mechanism comprising as set forth in claim 27 wherein the window/door opening are additionally protected from the wind and debris by side angles that are aligned along the right and left sides of the window/door opening, respectively.

29. The storm shutter assembly for a building external opening with quick emergency escape mechanism comprising as set forth in claim 27 wherein engaging wall and shutter members are elongated with U-shaped bars secured to the outside wall next to the opening and shutter panels, respectively, and the engaging sliding latch member with the locking means in the form of padlock.

30. The storm shutter assembly for a building external opening with quick emergency escape mechanism as set forth in claim 29 wherein all mounting is secured by screws are head flush bolts and tamper resistant screws, which provide additional prevention against gaining entrance to the premises.

31. The storm shutter assembly for a building external opening with quick emergency escape mechanism comprising as set forth in claim 30 wherein the padlock mechanism is equipped with a spring fixture allowing a quick release of the hasp from the apertures of the engaged members.

32. The storm shutter assembly for a building external opening with quick emergency escape mechanism comprising as set forth in claim 31 wherein enhanced protection against unauthorized removal of the panel is achieved by applying securing brackets that hide both the wall shutter fasteners and wherein the brackets are secured by the latching elongated member that can be removed only after the latch and engaging members are unlocked and the latching member is put in the released position.

33. A storm and guard shutter assembly for a building external opening with quick emergency escape mechanism comprising:
a shutter panel, and
two side members with a the quick emergency escape mechanism for a shutter assembly for a building external opening, which are mounted on both side bases of a building opening.

34. The storm shutter assembly with quick emergency escape mechanism for a building external opening comprising as set forth in claim 33 wherein the shutter panel includes a plurality of corrugated shutter overlapped panels aligned horizontally.

35. A storm and guard shutter assembly for a building external opening with quick emergency escape mechanism comprising:
a shutter panel,
a header member engaged with two side members, and a footer member,
the side members being equipped with a fork-lift flange having a horizontal slot on each of their top side for lifting and latching the top latch member and keeping it in an aligned position for allowing it to slide across the engaging parts of the header latching member, the slide members mounted on both side bases of a building opening, and the footer member being mounted on the sill of a building opening, the footer member being equipped with an engaging sliding member that is slid along the length of a latching member, the header member being mounted on the top side of a building opening and equipped with an engaging sliding removable member with pivot studs fastened to its left and right ends, the pivot stubs having an outer diameter allowing them to be inserted into the slot of the fork-lift flange which is slid across the length of the latching member.

36. The storm shutter assembly with quick emergency escape mechanism for a building external opening comprising as set forth in claim 32 wherein the shutter panel is a rigid monolithic panel.

37. The storm shutter assembly with quick emergency escape mechanism for a building external opening comprising as set forth in claim 36 wherein the shutter panel is a plywood panel.

38. The storm shutter assembly with quick emergency escape mechanism for a building external opening comprising as set forth in claim 36 wherein the shutter panel is a translucent polycarbonate panel.

39. A storm and guard shutter assembly for building external opening providing weather-tight and water-tight of the shutter around a building opening as well as additional thermal insulation qualities with quick emergency escape mechanism comprising:
a shutter panel equipped with a sealing gasket at the periphery of the shutter panel;
a header member engaged with two side members, and a footer member, which are equipped with engaging shutter members of variable cross-sectional shape allowing the shutter panel coupled with shutter members being shifted towards the building when the latch member is slid from open/unlocked to the fastened/locked position, thus providing the gasket compression and sealing the shutter panel against the building wall,
the side members being mounted on both side bases of a building opening and equipped with a fork-lift flange having horizontal slot on each their top side for lifting and latching the top latch member and keeping it in an aligned position allowing it to slide across the engaging parts of the header latching member,
the footer member being mounted on a sill of a building opening and equipped with an engaging sliding member that is slid along the length of a latching member, and
the header member being mounted on the top side of a building opening and equipped with an engaging slidable removable member with pivot studs fastened to its left and right ends and having the outer diameter allowing the studs to be inserted into the slot of the fork-lift flange which is slid across the length of the latching member.

40. The storm shutter assembly with quick emergency escape mechanism for a building external opening comprising as set forth in claim 39 wherein the shutter panel is a rigid monolithic panel.

41. The storm shutter assembly with quick emergency escape mechanism for a building external opening comprising as set forth in claim 40 wherein the shutter panel is a plywood panel.

42. The storm shutter assembly with quick emergency escape mechanism for a building external opening comprising as set forth in claim 40 wherein the shutter panel is a translucent polycarbonate panel.

43. The storm shutter assembly with quick emergency escape mechanism for a building external opening comprising as set forth in claim 39 and further including four angled bases in a rectangular configuration defining the opening for allowing easy mounting the latching assemblies as well as improving sealing the window opening in a locked position.

44. The storm shutter assembly with quick emergency escape mechanism for a building external opening comprising as set forth in claim 43 wherein the angled bases are fabricated of a non-corrosive weather proof aluminum.
